(19) United States
(12) Patent Application Publication
(10) Pub. No.: US 2017/0238455 A1
(43) Pub. Date: Aug. 24, 2017

(54) Adjustable Three Point Hitch System

(71) Applicant: Donald Marwitz, Manchaca, TX (US)

(72) Inventor: Donald Marwitz, Manchaca, TX (US)

(21) Appl. No.: 15/047,264

(22) Filed: Feb. 18, 2016

(51) Int. Cl. A01B 59/043; A01B 59/06

(52) U.S. Cl. CPC A01B 59/043; A01B 59/066

(57) ABSTRACT

An adjustable three point hitch system includes a frame that may be removably coupled to a tractor. The frame has a selectively adjustable width. Thus, the frame may be coupled to implements having a variety of widths thereby facilitating the tractor to draw the implements. A spreading unit is coupled to the frame and the spreading unit may be manipulated. The spreading unit urges the frame between a minimum width and a maximum width.

### BACKGROUND OF THE DISCLOSURE

### Field of the Disclosure

The disclosure relates to hitch devices and more particularly pertains to a new hitch device for coupling implements of varying widths to a tractor.

### SUMMARY OF THE DISCLOSURE

An embodiment of the disclosure meets the needs presented above by generally comprising a frame that may be removably coupled to a tractor. The frame has a selectively adjustable width. Thus, the frame may be coupled to implements having a variety of widths thereby facilitating the tractor to draw the implements. A spreading unit is coupled to the frame and the spreading unit may be manipulated. The spreading unit urges the frame between a minimum width and a maximum width.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a back perspective view of an adjustable three point hitch system according to an embodiment of the disclosure.

FIG. 2 is a right side view of an embodiment of the disclosure.

FIG. 3 is a top view of an embodiment of the disclosure.

FIG. 4 is a front perspective view of an embodiment of the disclosure.

FIG. 5 is a back perspective in-use view of an embodiment of the disclosure.

FIG. 6 is a left side perspective in-use view of an embodiment of the disclosure.

### DESCRIPTION OF THE PREFERRED EMBODIMENT

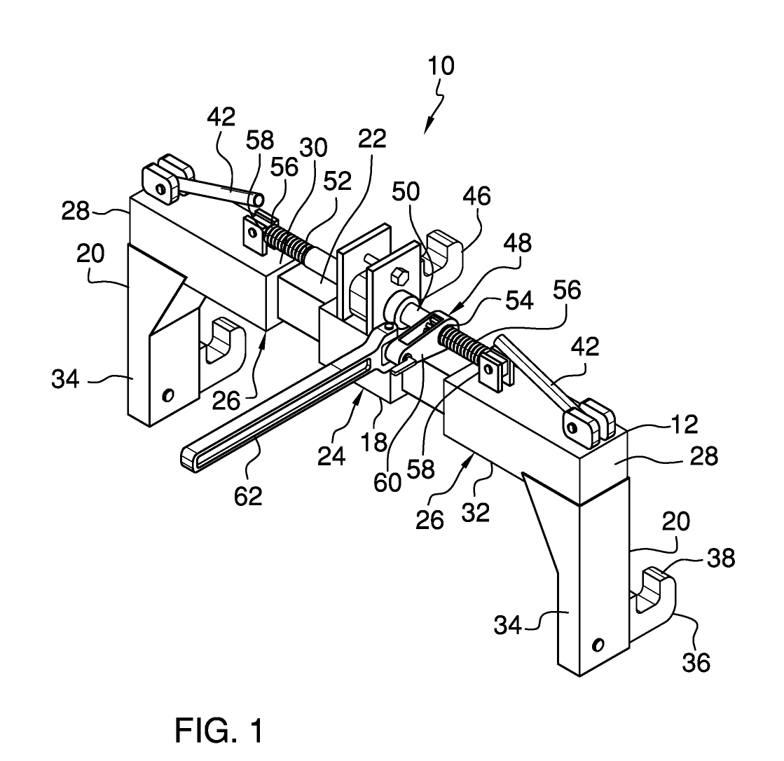

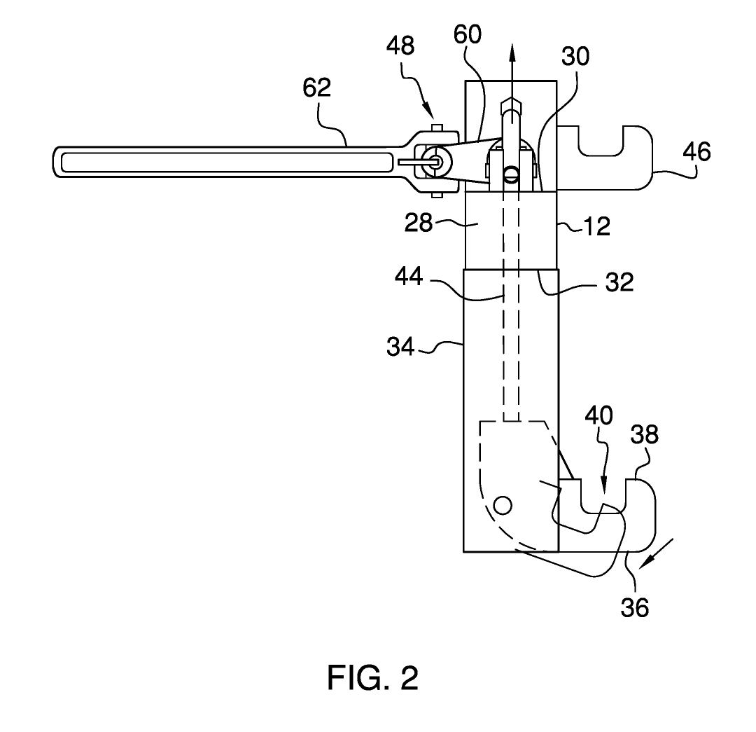

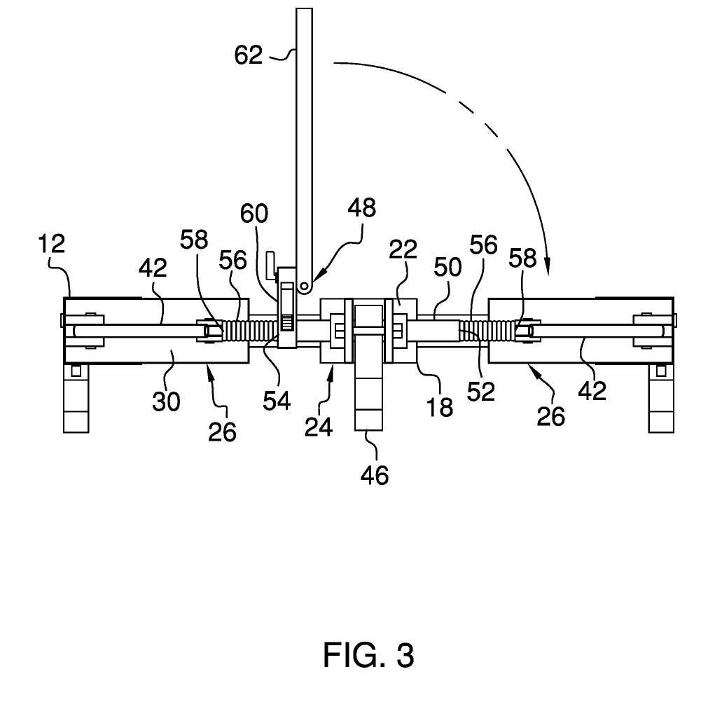

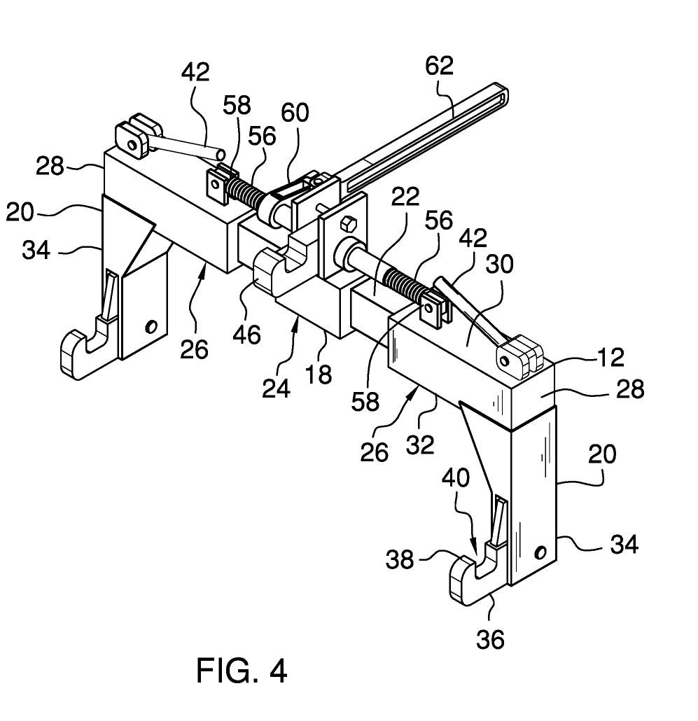

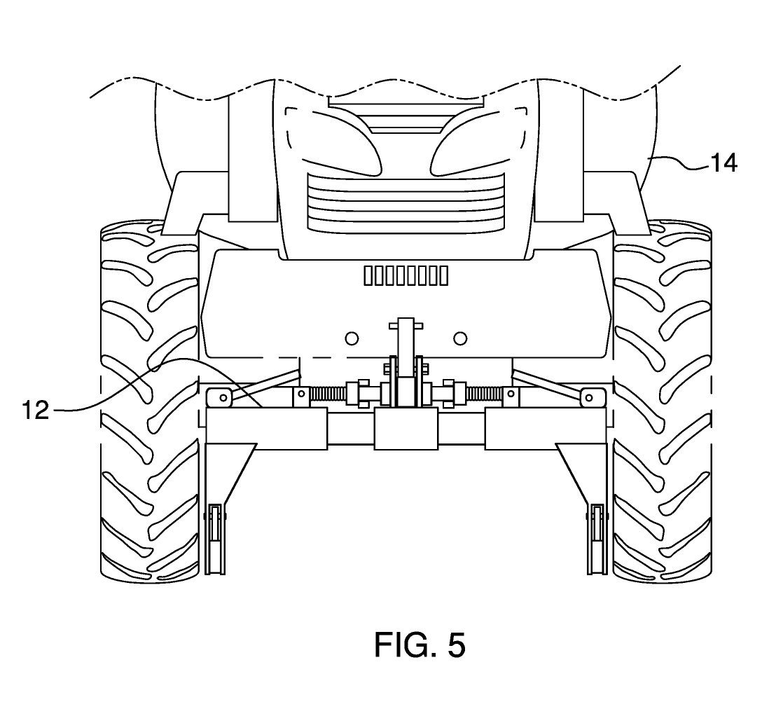

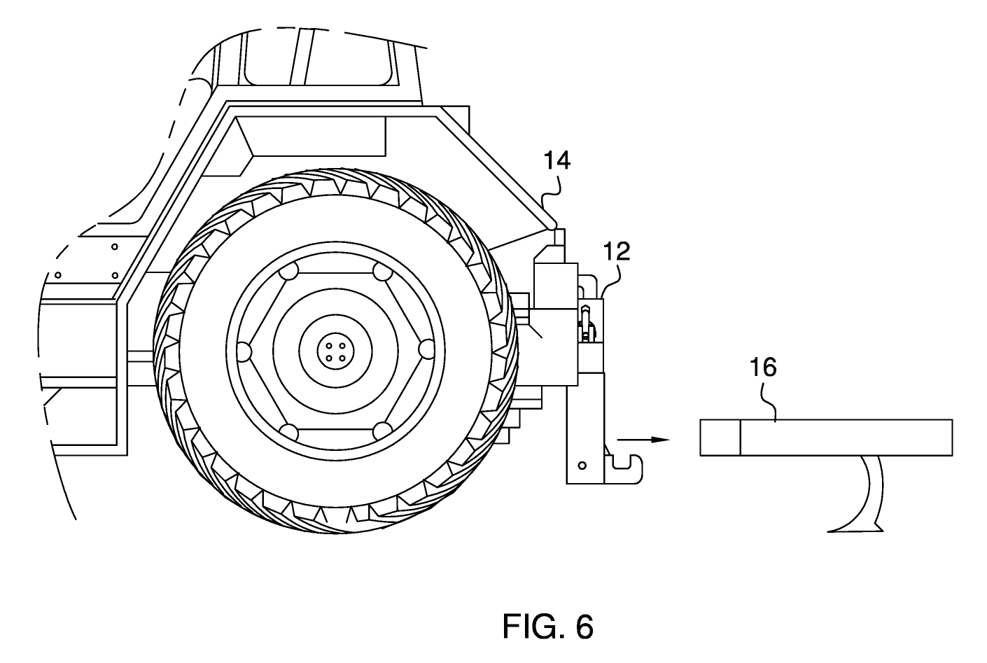

With reference now to the drawings, and in particular to FIGS. 1 through 6 thereof, a new hitch device embodying the principles and concepts of an embodiment of the disclosure and generally designated by the reference numeral 10 will be described.

As best illustrated in FIGS. 1 through 6, the adjustable three point hitch system 10 generally comprises a frame 12 that may be removably coupled to a tractor 14. The tractor 14 may comprise a farm tractor or the like. The frame 12 has a selectively adjustable width. Thus, the frame 12 may accommodate implements 16 having a variety of widths thereby facilitating the tractor 14 to draw the implements 16. The implements 16 may comprise farming implements or the like.

The frame 12 comprises a central member 18 extending between a pair of end members 20. The end members 20 are spaced apart from each other and each of the end members 20 extends downwardly from the central member 18. The central member 18 has a top side 22. The central member 18 comprises a middle portion 24 that is slidably coupled between a pair of terminal portions 26. Thus, central member 18 has a telescopically adjustable width. Each of the terminal portions 26 has a distal end 28 with respect to the middle portion 24, an upper side 30 and a lower side 32.

Each of the end members 20 comprises a leg 34 that is coupled to and extends downwardly from the lower side 28 corresponding to an associated one of the terminal portions 26. The leg 34 is positioned adjacent to the distal end 28 of the associated terminal portion 26. A foot 36 is hingedly coupled to the leg 30. The foot 36 has a top side 38 and the top side 38 of the foot 36 has a notch 40 extending downwardly therein. The notch 40 engages the implement 16 thereby facilitating the implement 16 to be removably coupled to the tractor 14.

A lever 42 is hingedly coupled to the upper side 26 of the associated terminal portion 26 and the lever 42 may be manipulated. A rod 44 extends between the lever 42 and the foot 36. The foot 36 is selectively raised and lowered on the leg 34 when the lever 42 is manipulated. Thus, the foot 36 selectively engages and releases the implement 16. The rod 44 is slidably positioned within the leg 34. A hook 46 is coupled to the top side 22 corresponding to the middle portion 24. The hook 46 selectively engages the tractor 14. Thus, the frame 12 is removably coupled to the tractor 14.

A spreading unit 48 is coupled to the frame 12 and the spreading unit 48 may be manipulated. The spreading unit 48 urges the frame 12 between a minimum width and a maximum width. The spreading unit 48 comprises a sleeve 50 that has a first end 52 and a second end 54. The sleeve 50 extends through the hook 46 such that the sleeve 50 is substantially coextensive with the middle portion 24. The sleeve 50 is rotatable about an axis extending longitudinally through the sleeve 50.

A pair of screws 56 is provided. Each of the screws 56 threadably engages the sleeve. Each of the screws 56 extends outwardly from an associated one of the first end 52 and the second end 54 of the sleeve 50. Each of the screws 56 has a distal end 58 with respect to the sleeve 50. The distal end 58 corresponding to each of the screws 56 is coupled to the top side 22 corresponding to an associated one of the terminal portions 26.

A ratchet 60 is movably coupled to the sleeve 50 and the ratchet 60 may be manipulated. The ratchet 60 rotates the sleeve 50 in a first direction having sleeve 50 urging each of the screws 56 to extend outwardly from the sleeve 50. Thus, the terminal portions 26 are urged outwardly from the middle portion 24. The ratchet 60 rotates the sleeve 50 in a second direction having the sleeve 50 urging each of the screws 56 to extend inwardly of the sleeve 50. Thus, the terminal portions 26 are urged inwardly toward the middle portion 24. The ratchet 60 may comprise a chain binder or the like.

The ratchet 60 includes a handle 62 that is foldably coupled to the ratchet 60 and the handle 62 may be manipulated. The handle 62 urges the ratchet 60 to rotate the sleeve 50 in the first direction and the second direction. The handle 62 is foldable between a deployed position and a stored position. The handle 62 is oriented perpendicular to the central member 18 when the handle 62 is in the deployed position. The handle 62 is coextensive with the central member 18 when the handle 62 is positioned in the folded position.

In use, the hook 46 is coupled to the tractor 14 thereby removably retaining the frame 12 on the tractor 14. The handle 62 is manipulated to position the frame 12 at a selected width that corresponds to the width of the selected implement 16. The lever 42 corresponding to each of the terminal portions 26 is manipulated to urge the corresponding foot 36 to engage the implement 16. Thus, the implement 16 is coupled to the frame 12. The lever 42 corresponding to each of the terminal portions 26 is manipulated to urge the corresponding foot 36 to disengage the implement 16. Thus, the implement 16 is removable from the frame 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An adjustable three point hitch system comprising:
a frame being configured to be removably coupled to a tractor, said frame having a selectively adjustable width wherein said frame is configured to be coupled to implements having a variety of widths thereby facilitating the tractor to draw the implements; and
a spreading unit being coupled to said frame wherein said spreading unit is configured to be manipulated, said spreading unit urging said frame between a minimum width and a maximum width.

2. The system according to claim 1, wherein said frame comprises a central member extending between a pair of end members, said end members being spaced apart from each other, each of said end members extending downwardly from said central member, said central member having a top side, said central member comprising a middle portion being slidably coupled between a pair of terminal portions such that central member has a telescopically adjustable width, each of said terminal portions having a distal end with respect to said middle portion, an upper side and a lower side.

3. The system according to claim 2, wherein each of said end members comprises a leg being coupled to and extending downwardly from said lower side corresponding to an associated one of said terminal portions, said leg being positioned adjacent to said distal end of said associated terminal portion.

4. The system according to claim 3, further comprising a foot being hingedly coupled to said leg, said foot having a top side, said top side having a notch extending downwardly therein wherein said notch is configured to engage the implement.

5. The system according to claim 4, further comprising a lever being hingedly coupled to said upper side of said associated terminal portion wherein said lever is configured to be manipulated.

6. The system according to claim 5, further comprising a rod extending between said lever and said foot such that said foot is selectively raised and lowered on said leg when said lever is manipulated wherein said foot is configured to selectively engage and release the implement, said rod being slidably positioned within said leg.

7. The system according to claim 6, further comprising a hook being coupled to said top side corresponding to said middle portion wherein said hook is configured to engage the tractor thereby facilitating said frame to be removably coupled to the tractor.

8. The system according to claim 1, wherein:
said frame includes a hook; and
said spreading unit comprises a sleeve having a first end and a second end, said sleeve extending through said hook such that said sleeve is substantially coextensive with said middle portion, said sleeve being rotatable about an axis extending longitudinally through said sleeve.

9. The system according to claim 8, wherein:
said frame includes a pair of terminal portions, each of said terminal portions having a top side; and
said spreading unit further comprises a pair of screws, each of said screws threadably engaging an associated one of said first end and said second end of said sleeve, each of said screws having a distal end with respect to said sleeve, said distal end corresponding to each of said screws being coupled to said top side corresponding to an associated one of said terminal portions.

10. The system according to claim 9, further comprising a ratchet being movably coupled to said sleeve wherein said ratchet is configured to be manipulated, said ratchet rotating said sleeve in a first direction having sleeve urging each of said screws to extend outwardly from said sleeve such that said terminal portions are urged outwardly from said middle portion.

11. The system according to claim 10, wherein said ratchet rotates said sleeve in a second direction having said sleeve urging each of said screws to extend inwardly to said sleeve such that said terminal portions are urged inwardly toward said middle portion, said ratchet being foldable between a deployed position and a stored position, said ratchet being oriented perpendicular to said central member when said ratchet is in said deployed position, said ratchet being coextensive with said central member when said ratchet is positioned in said folded position.

12. An adjustable three point hitch system comprising:
a frame being configured to be removably coupled to a tractor, said frame having a selectively adjustable width wherein said frame is configured to be coupled to implements having a variety of widths thereby facilitating the tractor to draw the implements, said frame comprising:
a central member extending between a pair of end members, said end members being spaced apart from each other, each of said end members extending downwardly from said central member, said central member having a top side, said central member comprising a middle portion being slidably coupled between a pair of terminal portions such that central member has a telescopically adjustable width, each of said terminal portions having a distal end with respect to said middle portion, an upper side and a lower side, each of said end members comprising:
a leg being coupled to and extending downwardly from said lower side corresponding to an associated one of said terminal portions, said leg being positioned adjacent to said distal end of said associated terminal portion,
a foot being hingedly coupled to said leg, said foot having a top side, said top side having a notch extending downwardly therein wherein said notch is configured to engage the implement,
a lever being hingedly coupled to said upper side of said associated terminal portion wherein said lever is configured to be manipulated, and
a rod extending between said lever and said foot such that said foot is selectively raised and lowered on said leg when said lever is manipulated wherein said foot is configured to selectively engage and release the implement, said rod being slidably positioned within said leg;
a hook being coupled to said top side corresponding to said middle portion wherein said hook is configured to engage the tractor thereby facilitating said frame to be removably coupled to the tractor; and
a spreading unit being coupled to said frame wherein said spreading unit is configured to be manipulated, said spreading unit urging said frame between a minimum width and a maximum width, said spreading unit comprising:
a sleeve having a first end and a second end, said sleeve extending through said hook such that said sleeve is substantially coextensive with said middle portion, said sleeve being rotatable about an axis extending longitudinally through said sleeve,
a pair of screws, each of said screws threadably engaging an associated one of said first end and said second end of said sleeve, each of said screws having a distal end with respect to said sleeve, said distal end corresponding to each of said screws being coupled to said top side corresponding to an associated one of said terminal portions, and
a ratchet being movably coupled to said sleeve wherein said ratchet is configured to be manipulated, said ratchet rotating said sleeve in a first direction having sleeve urging each of said screws to extend outwardly from said sleeve such that said terminal portions are urged outwardly from said middle portion, said ratchet rotating said sleeve in a second direction having said sleeve urging each of said screws to extend inwardly to said sleeve such that said terminal portions are urged inwardly toward said middle portion, said ratchet being foldable between a deployed position and a stored position, said ratchet being oriented perpendicular to said central member when said ratchet is in said deployed position, said ratchet being coextensive with said central member when said ratchet is positioned in said folded position.
